(19) United States
(12) Patent Application Publication
(10) Pub. No.: US 2013/0257127 A1
(43) Pub. Date: Oct. 3, 2013

(54) Field work vehicle with seat apparatus

(71) Applicant: James K. Bullis, Sunnyvale, CA (US)

(72) Inventor: James K. Bullis, Sunnyvale, CA (US)

(21) Appl. No.: 13/506,181

(22) Filed: Apr. 2, 2012

(51) Int. Cl. B60N 2/38; B60N 2/16; B60N 2/10; B60N 2/14; B60N 3/06; B62D 25/20

(52) U.S. Cl. 297/314; 296/75; 296/193.07

(57) ABSTRACT

Narrow agricultural vehicles have been invented to make farm labor more attractive, to enable enhanced productivity of workers, and to make possible more complete usage of land. This involves making the width of the vehicle approximately the same width as a seated worker, thus enabling vehicle use with narrowly spaced row crops. The wheel set is configured for both maximum stability and efficient operation on soft surfaces using large drum wheels that maximize a rigid, footprint area.

To enhance effectiveness of such vehicles, a seat apparatus is included to enable the seated worker to function without intrusion beyond a single narrow row space, yet sit in varied positions that are appropriate for field work and are conducive to increased productivity, comfort, and safety.

The vehicle structure includes a narrow tongue structure that connects between front and rear wheel arrangements with minimal interference with work of said worker.

This patent document contains material that is subject to copyright protection. Facsimile reproduction is allowed of the patent document or the patent disclosure as it appears in the Patent and Trademark Office patent file or records as allowed by US patent law, but otherwise all copyright rights are reserved.

### BACKGROUND OF THE INVENTION

1. Field of the Invention

This present invention relates to agricultural vehicles.

2. Description of the Prior Art

There is on-going concern for future agricultural productivity, given the expanding world population. This concern is further exacerbated by the practice of using feed grain crops for making motor vehicle fuel. It is paramount that we make the best possible use of agricultural resources. One way to do this is to greatly expand irrigation by distributing water on a continental basis. This enlargement of agricultural operations could lead to a need for far more agricultural workers. Real progress could be based on a new kind of apparatus that would enhance productivity of workers and make the work into a more attractive activity. The right kind of new vehicles could also make possible a higher use of land, where the commonly allotted space for tractor passage through plantings could be reduced, thus even further improve usage of agricultural resources.

Some kinds of agricultural work are hard, slow, and uncomfortable. It is difficult to find workers and pay them enough to get them to do such tasks. To improve this situation with a machine requires both better productivity and greater comfort of the worker. Productivity has to be better per worker in order to make the cost of the machine affordable. Worker comfort has to be provided to attract workers, but also to enable more effective and sustained performance of tasks. Cost of the machine has to be compatible with expectations for improved productivity. Perhaps of greatest importance is the need for energy efficient operation. Worker safety must be carefully considered in developing new apparatus.

Compared with most generally familiar vehicles, agricultural vehicles of the sort that would significantly assist farm workers have significantly different performance requirements, and some of these offer potential for unique new system solutions. The biggest of these is the fact that for manual work, unusually low speed is desirable. Another key difference is that the low seat that would enable workers to reach to the ground would mean that conventional notions of how to stabilize a vehicle are inapplicable; particularly, a wide wheel base is not needed. Furthermore, the low operator riding position means that stability need not be so absolute since a roll over event would not be particularly hazardous; as we would normally think of such events for farm tractors. A design freedom is the fact that the overall length of a vehicle oriented toward row crop work can be quite large, enabling a vehicle and various ancillary equipment configured in a narrow but long train.

We look at the historical background for apparatus of this sort in the vast field of agricultural vehicles. Not much is found in the way of mechanization to realistically aid hand work in the fields. Rather, the tendency seems to be to develop tractor based solutions or tractor like systems. Tractors make it possible for some kinds of farming to automate the work and to provide very comfortable cab conditions. For some types of crops this leads to very successful operations utilizing ever larger tractors and harvesters of many types. However, the present need seems to call for different approaches. In many situations, the needed work can simply can not be done from a large vehicle because of the need for hand work close to the ground or for workers to be in positions relative to growing crops that would be awkward from large vehicles. Large vehicles are often not desirable because the crops themselves interfere with access by such vehicles, and unfortunately, this can lead to farming methods where crop spacing does not make the best possible use of land resources, simply because land must be reserved to allow for the vehicle to pass.

An example situation where the vehicle prevents crop spacing that would make the best use of land resources is shown in U.S. Pat. No. 3,546,856 Hiyama 1970, FIG. 2. Somewhat better, but still intrusive is the apparatus of U.S. Pat. No. 4,250,700 Horn et al. 1981. A farming system where it is desirable to enable both the worker and vehicle to pass under growing crop vines as illustrated by the U.S. Pat. No. 3,546,856 Hiyama 1970, FIG. 1 and U.S. Pat. No. 5,423,166 Scott 1995, thus showing the disadvantages of vehicles of the size range usually found in farm vehicles. Further, U.S. Pat. No. 5,423,166 Scott 1995 illustrates the intrusiveness of both grape acquisition machinery and the associated trailer by which harvested grapes are collected.

There are prior art vehicle configurations that have been invented with these purposes in mind. U.S. Pat. No. 3,589,744 Hansen 1971 illustrates an apparatus intended to function as an aid to workers. This seems well suited for row crop work. Though the invention U.S. Pat. No. 3,589,744 Hansen 1971 seems to be useful, it is complicated. Conventional wheels with balloon type tires mounted are arranged in a three point stabilizing form, generally like many farm tractors, but also harking back to the three wheeled Morgan roadster of long ago. This is adapted to working on low growing crops with over-arching structure that allows passing over crop rows, but all this leads to complicated equipment, when simplicity is needed to allow inexpensive construction. Still this invention by Hansen is successful in providing a low seat for a worker that enables low crop access, all the way to ground level. Hansen shows one wheel that is relatively large which would help hold down drag when traversing over soft earth, but this of course does not indicate an attempt to use this for stability.

A hard cylindrical wheel concept was disclosed in prior application U.S. Ser. No. 13/199,968 Bullis 2011 in connection with an off road vehicle system intended substantially for agricultural purposes. That invention included a wheel made of thin steel in the form of a hollow cylinder including end caps. Slats were laid on the outer cylinder surface for providing a tread and for strengthening the ground contact surface, and it was noted that these could be rubber coated.

That invention U.S. Ser. No. 13/199,968 Bullis 2011 has the purpose of enabling operation in a narrow row space between row crops where a low seated worker would have ready access to plantings by virtue of a low seat, that seat being adjustable in height as appropriate for the work.

U.S. Pat. No. 2,583,358 Cesan 1952 shows a garden tractor that also relates to these general objectives, though it utilizes conventional pneumatic tired wheels in a conventional four wheel arrangement. Some stability would be achieved due to the weight of the low seated worker, when that is the position of the seat, but the conventional tires would not provide the stability of the hard wheel of Ser. No. 13/199,968 Bullis 2011. Further, the stability that would be achieved under guidance of U.S. Pat. No. 2,583,358 Cesan is particularly called into question by the highly placed machinery, especially the engine shown. It appears that stability issues mean that the design of U.S. Pat. No. 2,583,358 is incapable of operating in the very narrow row space that is possible with U.S. Pat. No. 13/199,968 Bullis 2011. The explicitly stated function of straddling the row of plantings would derive from this limitation, instead of the otherwise operation entirely between rows of plantings.

The individual wheels of that U.S. Pat. No. 2,583,968 Cesan 1952 invention are narrow in width and relatively small in diameter, which means that they would have relatively small ground surface contact and would sink into dirt such that significant loss of energy would occur when moving. U.S. Ser. No. 13/199,968 Bullis 2011 particularly addresses this effect using the wide, large diameter, hard wheel system to spread load over the ground surface.

Continuous track vehicles serve to enable operation on soft dirt. A wide variation of such a track would offer lateral stability to prevent roll over, should it be used for that purpose, and the included wheels with the track could provide a wide wheel base if needed. The wide range of use of tracked vehicles in agriculture is represented by U.S. Pat. No. 1,376,649 Schneider 1921 and U.S. Pat. No. 4,683,969 Littau 1987. U.S. Pat. No. 7,543,664 Nelson 2009 shows a rubber version, and though this is not indicated, this could be adapted to provide stability as well as load spreading benefits. Generally, vehicles using tracked wheel systems arrange for the tracks to act in widely spaced pairs to provide stability. Rubber forms of tracked systems are used in snow-mobiles, where the single track contributes somewhat to vehicle stabilization.

Comparing again to U.S. Pat. No. 3,589,744 Hansen 1971, a simpler vehicle would be the recumbent bicycle as illustrated with a sidecar in U.S. Pat. No. 6,565,106 Lopez 2003. With or without a motor or engine this at least shows the basic simplicity needed. A tricycle form of this recumbent bicycle is an obvious variation that can be occasionally seen in use, but this would be still quite useless for the present purpose given that these wheels, though large in diameter, are narrow such that they would sink in soft dirt and cause much resistance to vehicle movement. The obvious tricycle form often includes wide, laterally spaced wheel sets; significantly wider than what would be desired for carrying a worker between narrowly spaced rows.

A very simple aid to workers would be the wheeled stool of U.S. Pat. No. 3,614,120 Cicero 1971 where a seat is provided with a seat back at a slanted position that would make low work more comfortable. This invention shows wide wheels but these are shown as they are mostly for convenience, as they are indicated to be typical rubber balloon tires. Stability for this “Chair Cycle” depends on the use of the legs and feet of the worker, not a lot differently from the way one legged milk stools were stabilized by the user. Though perhaps this is a useful apparatus, it can not be considered in the category of significant mechanization.

The impediment to progress of the widely used rubber, balloon, tractor tire such is indicated in U.S. Pat. No. 3,589,744 Hansen 1971. This works fine where there is a pair of widely spaced wheels that achieves stability, but by itself offers little resistance to rolling sidewise. But wide spacing is exactly what we are not looking for, in order to accomplish the present purposes for enabling more effective field work.

Curiously, tractor tires of the 1920s utilized hard steel wheels with large spikes bolted to them, where these spikes were called lugs. Because the typical fanner used regular roadways to get tractors from field to field, these lugs caused much disruption of smooth road surfaces. All this went away with inflated rubber tires of the mentioned balloon type. Lugs might not matter to stability, and they could be advantageous in a low speed vehicle.

Searching for solid wheels that would improve stability with a narrow wheelbase turned up U.S. Pat. No. 1,210,056 Fairman 1916 where a narrow vehicle is fitted with hard wheels. This vehicle is questionable as to safety given the high seat position, and of course this configuration does not suggest any interest in enabling hand work on low crops. A tractor utilizing hard wheels configured of lateral slats overlaid with slanted gripping ridges is shown in U.S. Pat. No. 2,560,384 Crain 1951. Though far from the field of farm vehicles, a relevant solid drum wheel is shown in the baby carriage for use in soft dirt of U.S. Pat. No. 5,158,319 Norcia et al. 1992, though there is no low seat for farm work and no special stabilizing purpose involved other than that of conventional baby carriage wheels.

U.S. Pat. No. 6,752,228 Aoyama 2004 reminds us of a function of agricultural vehicles depending on existence of tow bar capabilities, but it also illustrates the difficulty that is encountered in making the seat position truly low. This particular invention is announced as one that enables a low profile operation.

The previously mentioned invention U.S. Pat. No. 2,583,358 Cesan 1952 is pertinent in that it is a form that enables work by a low seated worker. It is configured to enable the vehicle to straddle a row of plantings such that a worker could reach down between low, side rails and tend such plantings. Though U.S. Pat. No. 2,583,358 Cesan enables access directly in front and below the worker, the side rails that would interfere with work to the side at low heights.

FIG. 1 (prior art) shows the side structure 201 of the previously invented vehicle U.S. Ser. No. 13/199,968 Bullis 2011. This vehicle is well suited for use in row crop work on a field 202 tending planted rows 203. The narrow vehicle 222 is configured to be narrow in width 210 to fit in a single row space 205 between two rows of plantings 204, driving in forward direction indicated 209. This particularly long 222 vehicle is designed in recognition of the generally long available space of a large field, thus the equipment is distributed over length rather than width as with typical vehicles. Though light weight is possible with a box-like general structure, the side panels 201 and upper rails 206 limit access to field crops. Access to plants at the ground level is troublesome due to both the floor and side structure of this vehicle.

In addition to side interference shown in FIG. 1 (prior art), that figure also makes clear a further limitation of that configuration, that being due to a simple seating arrangement. Here there is a narrow vehicle 222 of indicated width 210 for operating in a field 202 of row crops 203, in a row space 205 between two rows 204. It travels along the row space 205 in the direction indicated 209. The worker is provided only with seating to enable facing forward and an upright position. Thus, a need to reach into plant growing space is not supported. Particularly problematic is the risk of worker injury due to twisting positions.

### SUMMARY OF THE INVENTION

The present invention relates particularly to the previous narrow vehicle invention of U.S. Ser. No. 13/199,968 Bullis 2011, and another by Bullis filed Mar. 14, 2012 which are incorporated here by reference.

The vehicle is narrow such that it fits in a single row space and enables a worker to sit generally facing forward such that there is access to crops on each side. The seat is capable of being in a very low position whereby the worker can reach to near ground level. The overall vehicle is approximately the same width as the seated worker. Stabilization is provided by a front and a rear wheel set that is configured to give a stable vehicle stance, even though it is exceptionally narrow. Energy efficient operation is achieved by the use of wheel sets that maximize ground contact area.

The narrow vehicle is enhanced with a seat apparatus that enables improved access to the sides of the vehicle, where the seat arrangements are adaptable to work needs. The functions of a worker that are enabled include a leaning action that enables the worker to reach to the side, while still generally seated facing forward, and a double axis rotational action that enables the worker to face to a side and assume a work position that stays within an envelope of the vehicle except for arms that reach beyond. The work positions are designed to enable the occupational safety and comfort of workers.

The seating system is integrated into the efficient and stable narrow vehicle, thus providing a farm vehicle that would improve worker productivity while enabling more effective use of land.

### BRIEF DESCRIPTION OF THE DRAWINGS

FIG. 1 Agricultural vehicle working in field of row crops (prior art)

FIG. 2 Agricultural vehicle enabling a forward facing worker with an extended reach to a side due to tilting action

FIG. 3 Agricultural vehicle including a seat apparatus that enables worker rotation about a vertical axis

FIG. 4 Plan view to show unacceptable leg extension beyond vehicle envelope arising from limited flexibility of seat apparatus

FIG. 5 Agricultural vehicle including two axis rotational apparatus enabling an effective, side facing, work position

### DETAILED DESCRIPTION

The background art clearly shows limited extension of industrial technology to the agricultural world to provide what could be important changes in agricultural practice. Thus that practice carries on inadequately, seemingly unaware that industrial approaches could minimize the difficulty and discomfort of the work, not to mention what such approaches could do to enhance productivity of both workers and land. Surprisingly, it appears that it is possible to make agriculture significantly more profitable.

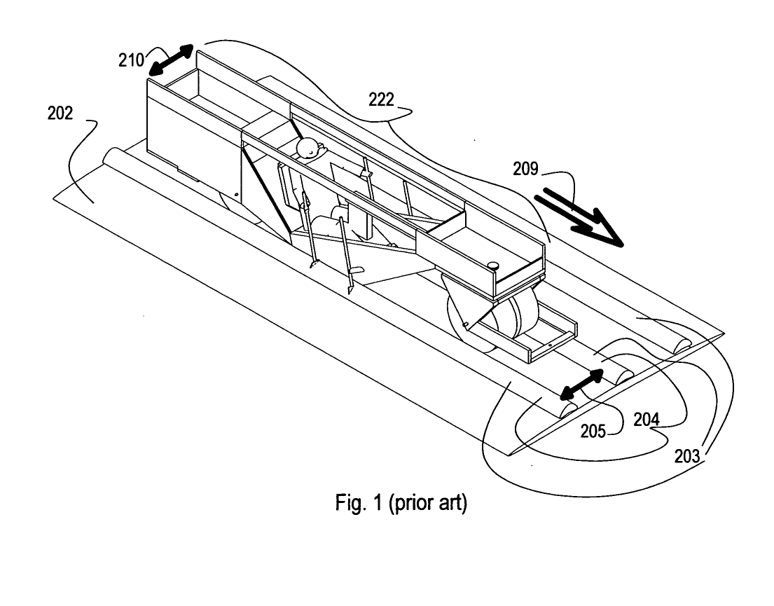

FIG. 1 (prior art) showed an initial concept vehicle for operating in a single row space and enabling much improved access to crops and much improved working conditions. Not only is there interference with access past the vehicle sides, the simple seat fails to support work positions that would be needed for many kinds of crop work.

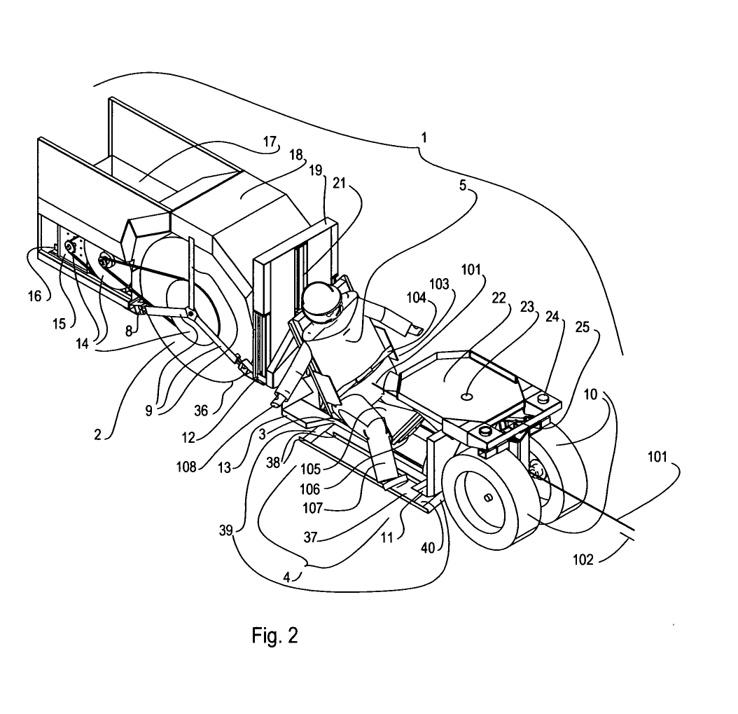

FIG. 2 shows one operation of the here invented vehicle 1. The worker 5 is shown with his right arm 108 extended into space that plants would occupy. The seat apparatus is held on structure 106 that tilts about a longitudinal axis 101 that is above a center of gravity, as indicated 102, of seat apparatus in combination with worker 5. Worker 5 sits on seat base 105. The worker's right leg 107 is shown putting force on right flap 37 which enables access to crops in space indicated by bracket 4. Worker safety is enhanced by side restraints 103 and belt 104. When the worker's right leg 107 is placed on the foot rest 11, the flap 37 moves up by spring action, thus preparing for vehicle 1 motion. With a raised flap, access to crop space is infringed. Open space 40 is due to the fact that right and left flaps do a form of pass by of each other since hinging of each flap on arms 37 is generally functioning on the far opposite side of the vehicle for respective flaps. This keeps the flaps nearly flat to the ground when in lowered position.

The vehicle 1 utilizes a wide rigid wheel system 2 that provides maximum stability and causes a minimum of energy loss due to earth depression. Front 10 and rear wheel 2 wheel systems are connected by a low and narrow tongue structure 3 over which is generally seated a worker represented by place holder 5. The tongue 3 is shaped to enable an approach 4 to low plant and ground levels. The ground accessible ground space 4 is indicated. Structure interfacing of the tongue 3 with the rear frame includes a brace 13 which is useful for imparting turning force to the wide rear wheel system 2. Turning force on the rear wheel 2 is not insignificant due to its solid and wide surface contact and significant concentration of vehicle weight on this rear wheel 2 through the use of the arch structure 18 and weight bearing strap system 9. The vehicle 1 is configured to have a very low center of gravity, that center of gravity being lower even than the rear wheel axle, especially when it is noted as pointed out in FIG. 2 that batteries are carried under the truck bed 17. Rails 21 mounted on vertical structure 19 enable vertical motion of seat apparatus.

Vehicle parts include a direction controlling wheel set 10 that is minimally loaded, where closely spaced wheels provide some spreading of that modest load over the ground surface. These can be rubber or hard cylinders, and though hard cylinders are preferred for stability practicality suggests use of readily available rubber tires. Front wheels are mounted on pivoting apparatus that provides a vertical pivot axis for each, and in this configuration, this axis is positioned to minimize forces that could cause steering annoyances. Steering is with a tiller that operates through tiller pivot bearing 23 to control these pivot mounted 24 front wheels through control rods 25. This control functions under the work tray 22 provided for worker use.

Further details include a foot rest 11, seat positioning rollers (available as ‘heavy duty skate wheels’ from McMaster-Carr industrial supply) on the side 12 and center 21 which enable change of seat height, these operating on rails mounted on wall 12 which is attached to the arch structure 18. A truck space is provided 17 with battery space underneath such that batteries are carried on the lowest level of the rear of the vehicle. Trailer attachment 16 is indicated An access panel is off to show how drive force is generated with the DC electric motor 15 (Mars P/N ME0709) which drives a chain and sprocket (also from McMaster Carr as standard roller chain and sprockets) gearing system 14 which drives the large wheel 2. The motor control is by simple incremental electrical switching, though continuous variable speed control is known in the industry. The large wheel 2 is specially formed to provide the benefits of a large wheel without the usual weight of such. Thus, it is a drum formed of sheet metal, provided with bearings and held with straps 9 that carry weight but do little to keep the wheel 2 from moving laterally. However, lateral stabilizing roller 8 and its opposite side counterpart are placed as shown to keep proper alignment of this light weight drum system. Safety side panels would enclose the wheel and chain drive equipment, though such panels are removed here for clarity.

A sun shade panel is not shown, but is an obvious part of a system that is intended to make farm work attractive.

The previous invention, U.S. Ser. No. 13/199,968 Bullis 2011, disclosed slats that have a rubber surface being attached to the drum to provide strength at the surface and a slightly soft ground contract surface. Presently, track pads from the heavy track vehicle industry are being utilized as the slats 36; these having been acquired from McLaren Industries, as part Hybrid Rubber Shoes 350 MM. The fact of generally low center of gravity, low operating speed makes it possible that the wide and firm drum wheel system 2 provides the needed stability. And of course, the large area footprint of such a wheel system 2 means the whole vehicle will operate much more efficiently than vehicles with wheels having a smaller footprint.

It is encouraging to observe the light weight structures being produced with the use of triangular and trapezoidal panel shapes made of 16 gauge sheet metal, with 11 gauge sheet metal at points of stress concentration. This construction has demonstrated the validity of the small tongue connecting structure as shown. Thus, the wall 19 structure, the arch 18 structure and the rear compartments are configured to transfer the more significant loads to the large wheel 2 axle, while meeting a light weight objective. Low cost production is anticipated based on this development work.

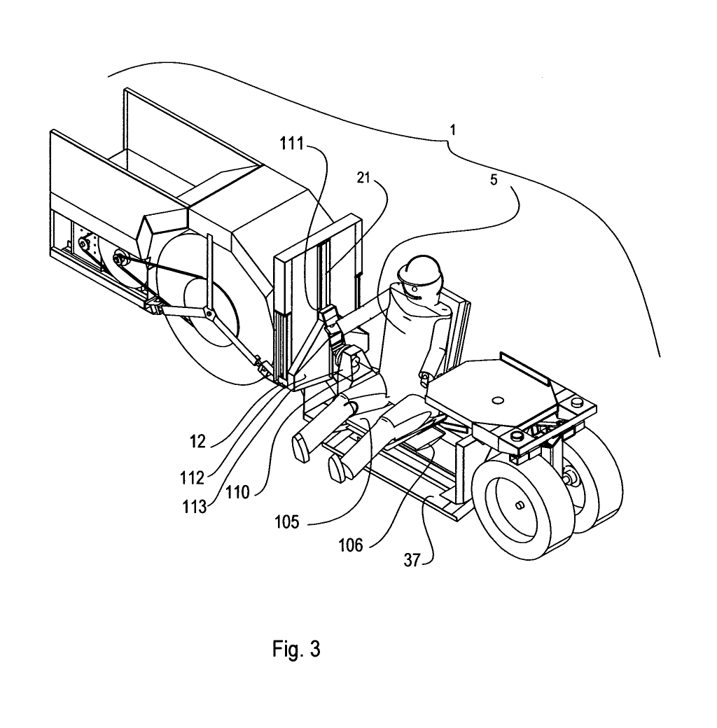

FIG. 3 shows a rotated worker placeholder 5 with seat base 105 rotated 90 degrees with respect to seat support structure 106 about a mutually perpendicular axis. A thrust type bearing is provided to ease the rotational action. Translational motion of seat base 106 relative to seat support structure 106 is also eased by roller apparatus.

Clearly, there is an awkward position arising from the simple action illustrated in FIG. 3. However, provision is shown to solve this problem. Seat support structure 106 is an extension of swinging structure 113 that rides on swing bearing 110. Height adjustment traveler 112 is a structure that rides on rollers 12,111 that ride on tracks such as center track 21. Tracks are mounted on vertical structural panel 19.

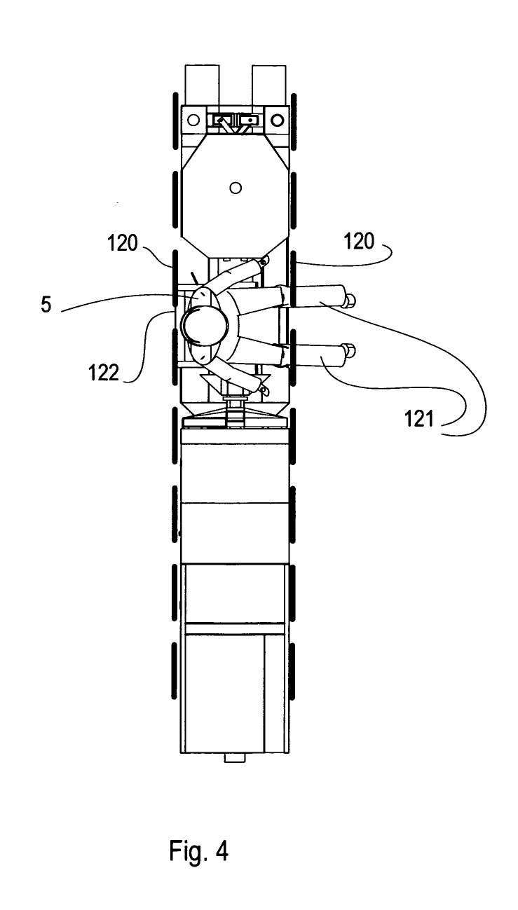

FIG. 4 explains the difficulty encountered by a side facing worker in operation intended for use in narrow row space. The intended vehicle envelope 120 of the vehicle is exceeded by legs 121 of worker placeholder 5. The upper part of the seat back 122 is at the limit of the envelope on the opposite side, so simply sliding the seat back is not a solution.

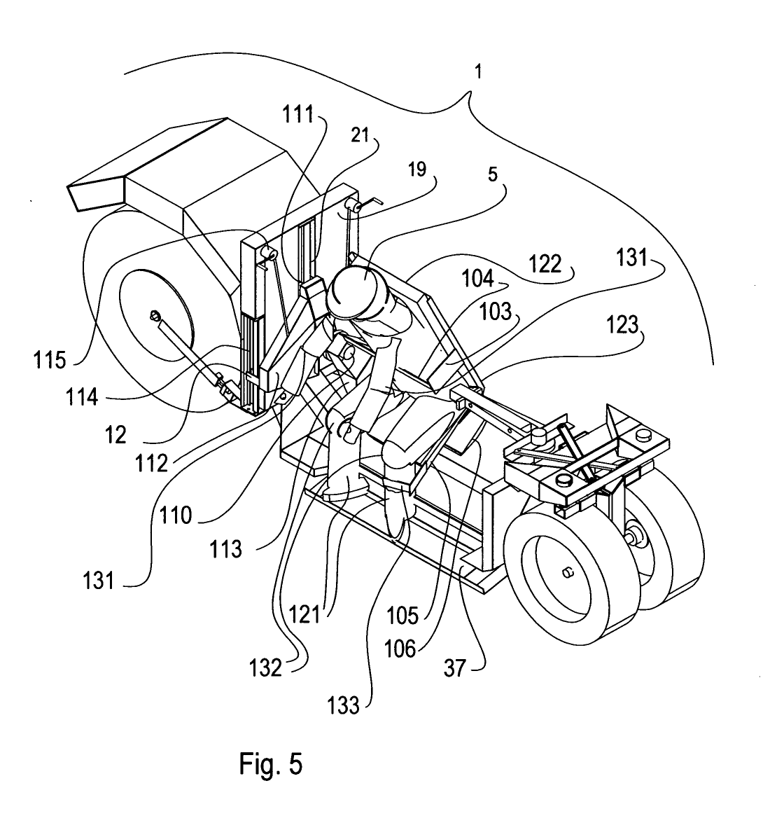

FIG. 5 is an expanded view of the seat apparatus that shows the invented solution to the side facing worker problem. An intended body position that needs to be supported by the wheel system is represented by the body position of worker placeholder 5. Instead of sliding his seat toward his back, the worker would be able to utilize the swing seat provisions, where the seat support structure 113, 106 pivots on the longitudinal axis bearing 110 such that the upper edge of seat back 122 moves toward the inside of the vehicle and the lower edge of the seat back 123 moves to the left side vehicle envelope shown in FIG. 4. This would enable the worker to draw his legs 121 to the inside of the vehicle envelope, to rest his feet on the lowered flap 37. If the seat is kept very low, the worker would be able to sit in a nearly ideal work position known as the garland pose in yoga. This is a familiar sitting position in some parts of the eastern world. Reality is that this is not so easy for many workers, and a transitional position is needed. The Yoga Journal describes a beginner, transitional, position for the garland pose as sitting on the front of a chair with thighs parallel to the ground. Then the person leans forward with elbows 131 between the spread out knees 133. The seat system needs to support such a transitional position to accommodate most field workers. People have variable capabilities in this regard, so the seating system needs to reflect this fact. Hence, a height adjustment capability is included in the seating system, where a winch 115 is a means to raise the back structure 112 which moves on rollers 12,111 which travel on rails 114, 21, thus raising the tilt axis. Winch 115 is mounted on vertical structure 19 to enable an operator to raise and lower the seat system. FIG. 5 also shows an example leaning aid 133 that can be attached to help the worker stay on the seat 105 surface. Aids are provided to assist a worker in safely working in the shown position include side supports 103 and safety belt 104.

For prototype implementation of machinery functions, extensive use has been made of inexpensive spindles and hubs from the highway trailer vehicle world. This minimized cost while incurring a minor penalty of not minimizing weight. There are, of course, many variations of the here described invention that one familiar with machine design would readily utilize, and one would expect production methods to be quite different from those described here.

The use of an electric motor and batteries is particularly attractive, though addition of an auxiliary engine is anticipated in many cases, and even a fully mechanical drive system has its uses in some applications.

The scope of the invention is to be defined by the appended claims.

I claim:

1. A vehicle for agricultural work that includes a frame with an attached set of wheels and an attached seat for a worker, where provision is made for said seat to be carried at a height that is appropriate for work, where said seat enables said worker to ride facing in the direction of forward vehicle motion, and where said seat includes a tilting apparatus that enables rotational motion of said seat about a longitudinal axis that enables an extended reach of said worker to a side of said vehicle, where that extended reach is with respect to normal reach of said worker when sitting approximately vertically upright with zero tilt angle about said longitudinal axis.

2. A vehicle according to claim 1 that is a narrow vehicle, where said set of wheels includes a wide wheel set having width that is approximately that of said worker thus seated, where said wide wheel set provides stabilization according to width to outer edges of said wide wheel set, where said stabilization acts to prevent roll over of said narrow vehicle.

3. A vehicle according to claim 1, where said tilting apparatus enables rotational motion of said seat about a longitudinal axis, where said axis is above a center of gravity of a said worker in combination with said seat, and such apparatus enables said seat to return to said vertical without significant force to do so from said worker.

4. A vehicle according to claim 1, where said seat is equipped to enable rotational motion of said seat such that it enables said worker to face to a side of said vehicle.

5. A vehicle according to claim 1, where said seat is equipped to enable rotational motion of said seat about an orthogonal axis such that it enables said worker to face to a side of said vehicle, where said orthogonal axis is perpendicular to said longitudinal axis.

6. A vehicle according to claim 1 that is a narrow vehicle, with seat apparatus that enables a combination of rotational motions about both a longitudinal axis and an orthogonal axis that is perpendicular to said longitudinal axis, where said combination rotational motions enables a side facing worker position that is approximately within a vehicle envelope of said narrow vehicle except for selected arm reach outside said vehicle envelope.

7. A vehicle according to claim 1 that is a narrow vehicle, with seat apparatus that enables a combination of rotational motions about both a longitudinal axis and an orthogonal axis to enable a side facing worker position that is approximately within a narrow vehicle envelope except for deliberate arm reach outside said envelope, where said worker position is a posture with feet near ground level and at least one elbow between legs, at or below knee level.

8. A vehicle according to claim 1, with seat apparatus that swings from a bearing axis that is near in height to a center of gravity of said worker in combination with said seat apparatus.

9. A vehicle according to claim 1 that is equipped with a moveable flap that is mounted near floor level of said vehicle, where said flap is mechanized to enable it to be lowered to near ground level such that a foot of said worker is supported on a base position that is not in contact with ground surface.

10. A vehicle according to claim 1 that is equipped with a moveable flap that is mounted near floor level of said vehicle, where said flap is mechanized to enable it to be lowered to near ground level such that a foot of said worker is supported on a base position that is not in contact with ground surface, and said flap is configured to enable it to be lowered by downward pressure of said foot.

11. A vehicle according to claim 1 that includes capability for height adjustment of said seat.

12. A vehicle for agricultural work that includes a frame with an attached set of wheels and an attached seat for a worker, where provision is made for said seat to be carried at a height that is appropriate for work, where said seat enables said worker to ride facing in the direction of forward vehicle motion, where said set of wheels includes a wide wheel set having width that is approximately that of said worker thus seated, where said wide wheel set provides stabilization according to width to outer edges of said wide wheel set, where said stabilization acts to prevent roll over of said narrow vehicle, where said seat involves seat apparatus that enables a combination of rotational motions about both a longitudinal axis and an orthogonal axis that is perpendicular to said longitudinal axis, where said combination enables a side facing worker position that is approximately within a vehicle envelope except for selected arm reach beyond said envelope, where said worker position is a posture with feet near ground level and an elbow between legs, at or below knee level.

13. A vehicle according to claim 12, where said side facing work position enables access to crops to a side of said vehicle at varying heights above ground, including near ground level.

14. A vehicle according to claim 12, where said work position approximates a yoga position known as garland.

15. A vehicle according to claim 12 that is equipped with a moveable floor panel of said vehicle, where said floor panel is mechanized to enable it to be lowered to near ground level such that said feet are provided with a base surface that is not a ground surface.

16. A vehicle according to claim 12 that is equipped with a moveable floor panel of said vehicle, where said floor panel is mechanized to enable it to be lowered to near ground level such that said feet are provided with a base surface that is not a ground surface, and where said moveable floor panel is mechanized to enable said feet to force it downward to near ground level.

17. A narrow vehicle to enable efficient farm work by a worker, where said narrow vehicle includes a frame in two parts, where said two parts are connected by a low placed tongue structure that is significantly narrower than said narrow vehicle to maximize access to crops near ground level, and where said narrow vehicle is equipped with a seat apparatus such that a seat is attached to said frame through a rotational bearing apparatus and through a vertically adjustable support structure, where said seat apparatus enables said maximum access to crops.

18. A narrow vehicle according to claim 17, where seat of said seat system rotates about additional axes to enable a side facing work position having ergonomic qualities that are conducive to safety of said worker.

19. A narrow vehicle according to claim 17, where said swing seat system operates in combination with rotation about other axes to enable variation of orientations of said worker.

20. A narrow vehicle according to claim 17, where said seat system enables independent adjustability of a seat surface.
